(19) United States
(12) Patent Application Publication
(10) Pub. No.: US 2026/0134191 A1
(43) Pub. Date: May 14, 2026

(54) COMPUTER SYSTEM AND METHOD FOR SUPPORTING MULTI-LANGUAGE FILE PROCESSING

(71) Applicant: Nuvoton Technology Corporation, Hsinchu Science Park (TW)

(72) Inventor: Yi-Hsien CHUANG, Kaohsiung City (TW)

(21) Appl. No.: 19/339,960

(22) Filed: Sep. 25, 2025

(30) Foreign Application Priority Data
Nov. 8, 2024 (TW) 113142949

(51) Int. Cl. G06F 40/126

(52) U.S. Cl. CPC G06F 40/126

(57) ABSTRACT

A computer system for supporting multi-language file processing is provided. The computer system includes a storage unit and a processing unit. The storage unit stores a graphical user interface (GUI) program and a file. The processing unit loads the GUI program from the storage unit to perform the following steps. The processing unit receives a filename expressed in a first language and encoded with a first character encoding standard, and generates an alias expressed in a second language using the same encoding. The processing unit links the alias name to the file so that both the filename and the alias name refer to the file. The processing unit converts the alias name to follow the second character encoding standard, so as to enforce low-level processing that follows the second character encoding standard on the file to which the alias name refers.

### CROSS REFERENCE TO RELATED APPLICATIONS

This application claims priority of Taiwan patent application No. 113142949, filed Nov. 8, 2024, the entirety of which is incorporated by reference herein.

### TECHNICAL FIELD

The present disclosure relates to a GUI program, and, in particular, it relates to a GUI program that supports multi-language file processing.

### BACKGROUND

A Graphical User Interface (GUI) is a way for users to interact with a computer system or application through visual images and icons. Unlike the earlier Command Line Interface (CLI), a GUI typically includes visual components such as windows, buttons, icons, drop-down menus, and dialog boxes, allowing users to interact with the interface using a mouse and a keyboard. To display and process multiple languages and symbols, GUIs commonly utilize Unicode.

Unicode is a character encoding standard designed to assign a unique code to every character and symbol in the world, allowing characters from different languages to be consistently represented and processed across various computer systems, software, and networks. Unicode supports characters from various languages, such as English, Chinese, and Japanese, as well as special symbols and emojis. By using multiple encoding forms (e.g., UTF-8, UTF-16), it enables cross-platform character processing and resolves the incompatibility issues that afflicted previous encoding systems.

Before the release of Unicode in 1991, other character encoding standards had already been extensively developed, and a large number of related static libraries and dynamic-link libraries (DLLs) had accumulated. These character encoding standards, such as the American Standard Code for Information Interchange (ASCII) and the Multi-byte Character Set (MBCS), did not assign unique codes to characters in languages other than English. The following will explain MBCS by way of example.

MBCS is a character encoding standard that allows the use of more than one byte to represent a character. It uses a single byte to represent basic English letters and symbols, while characters in other languages, such as Chinese, Japanese, and Korean, require multiple bytes. Depending on the language, MBCS can be further categorized, such as BIG5 for Traditional Chinese, GB2312 for Simplified Chinese, and EUC-KR for Korean. These languages share the same byte range. In other words, they use the same set of MBCS codes. This means that the same MBCS code may correspond to different characters depending on the language. The specific character that an MBCS code represents is determined by the language pack used by the operating system. For example, the MBCS code 0xB0A1 represents the Chinese character “ [symbol] ” in Simplified Chinese (GB2312), but it represents the Korean character “ [symbol] ” in Korean (EUC-KR).

In order for a current GUI program that uses Unicode to continue using executable files, static libraries, or dynamic libraries based on MBCS to process multi-language files, it must rely on application programming interfaces (APIs) provided by the operating system to convert Unicode characters into MBCS characters. For example, the MultiByteToWideChar( ) function provided by Windows can be used to convert Unicode characters into MBCS characters. Since this conversion also depends on the language pack used by the operating system, users of the GUI program must install the corresponding language pack based on the language being used. In other words, when switching between different languages, users must manually change the system language. Furthermore, when a string contains characters from multiple languages, the conversion may result in invalid MBCS characters. Therefore, this approach has many limitations and causes significant inconvenience for users of GUI programs.

Accordingly, there is a need for a computer system and method that support multi-language file processing and that can solve the problems described above.

### BRIEF SUMMARY

An embodiment of the present disclosure provides a computer system that supports multi-language file processing, comprising a storage unit and a processing unit. The storage unit stores a graphical user interface (GUI) program and a file. The processing unit loads the GUI program from the storage unit to perform the following steps. The processing unit receives the filename of the file, wherein the filename is represented in a first language and conforms to a first character encoding standard. The processing unit creates an alias name for the filename, wherein the alias name is represented in a second language and also conforms to the first character encoding standard. The processing unit links the alias name to the file so that both the filename and the alias name reference the file. The processing unit converts the alias name to conform to a second character encoding standard in order to launch a low-level processing operation on the file referenced by the alias name in accordance with the second character encoding standard.

An embodiment of the present disclosure provides a method for supporting multilingual file processing, implemented in a computer system comprising a storage unit and a processing unit. The storage unit stores a graphical user interface (GUI) program and a file. The processing unit loads the GUI program from the storage unit to execute the method, which includes receiving a filename of the file, wherein the filename is represented in a first language and conforms to a first character encoding standard. The method includes creating an alias name for the filename, wherein the alias name is represented in a second language and also conforms to the first character encoding standard. The method includes linking the alias name to the file such that both the filename and the alias name reference the file. The method includes converting the alias name to conform to a second character encoding standard in order to launch low-level processing on the file referenced by the alias name in accordance with the second character encoding standard.

The computer system and method for supporting multi-language file processing as provided in the present disclosure enable a file to be executed or processed by static and dynamic libraries that do not support multi-language filenames, regardless of the language in which the filename is represented. More specifically, by creating an alias for the filename and linking the alias to the file, the file can be executed or processed even if the original filename is in a language not supported by such libraries. This eliminates the need for GUI program developers to implement separate libraries that support multi-language filenames, thereby reducing development and maintenance costs. Furthermore, users of the GUI program are not required to manually install or switch system locale or language packs, making the usage of the GUI program simpler and more user-friendly.

### BRIEF DESCRIPTION OF THE DRAWINGS

The present disclosure can be more fully understood from the following descriptions of exemplary embodiments in conjunction with the accompanying drawings. It should also be understood that in the flowcharts of this disclosure, the execution order of the blocks may be changed, and certain blocks may be modified, omitted, or combined.

FIG. 1 shows a system architecture diagram of a computer system according to an embodiment of the present disclosure;

FIG. 2 shows a flowchart of a method according to an embodiment of the present disclosure;

FIG. 3 shows a flowchart of a method according to an embodiment of the present disclosure; and

FIG. 4 shows a flowchart of a method according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

In the embodiments listed below, the same reference numerals are used to represent the same or similar elements or components.

In this specification and in the claims, terms such as “first,” “second,” and so on are used only for convenience of description and do not imply any particular order or sequence.

The descriptions of the embodiments of a device or system in this specification are also applicable to the embodiments of a method, and vice versa.

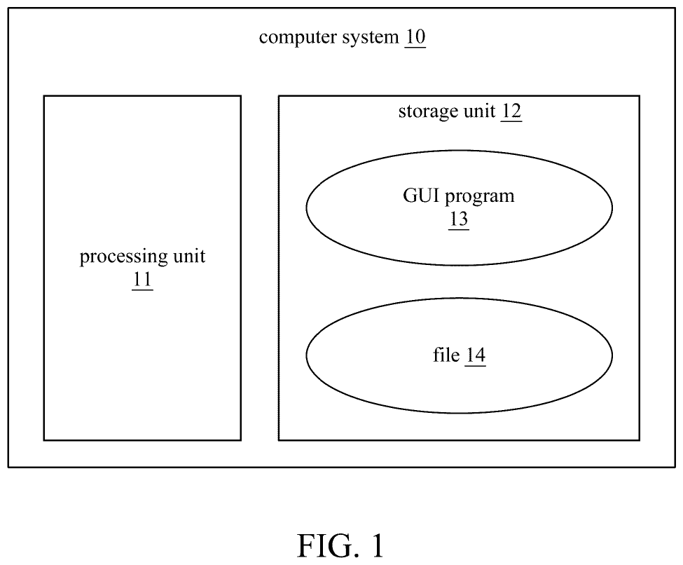

FIG. 1 shows a system architecture diagram of a computer system 10 according to an embodiment of the present disclosure. As shown in FIG. 1, the computer system 10 includes a processing unit 11 and a storage unit 12. The storage unit 12 stores a GUI program 13 and a file 14.

The computer system 10 can be any computer system or processing device with computing capability, such as a personal computer, including a desktop or laptop, a server computer, or a mobile device, such as a tablet or smartphone. However, the present disclosure is not limited to these examples.

The processing unit 11 can include one or more general-purpose or dedicated processors or a combination thereof used to execute instructions, such as a central processing unit (CPU) and/or a graphics processing unit (GPU). The processing unit 11 may also include volatile memories such as dynamic random access memory (DRAM) and/or static random access memory (SRAM). However, the present disclosure is not limited to these examples.

The storage unit 12 may include any device containing non-volatile memory, such as a hard disk drive (HDD), solid-state drive (SSD), or optical disk. Examples of non-volatile memory include read-only memory (ROM), electrically-erasable programmable read-only memory (EEPROM), flash memory, and non-volatile random access memory (NVRAM). However, the present disclosure is not limited to these examples.

The program logic of the GUI program can be implemented using any programming language and framework, such as JavaScript and React, or Python and PyQt. However, the present disclosure is not limited to these examples. The user interface (UI) of the GUI program can be designed using any design tools, such as Figma or Adobe XD. Again, the present disclosure is not limited to these tools. The file 14 can be any type of file, such as text files, image files, audio files, video files, code files, executable files, and so on. The present disclosure is not limited to these types of files.

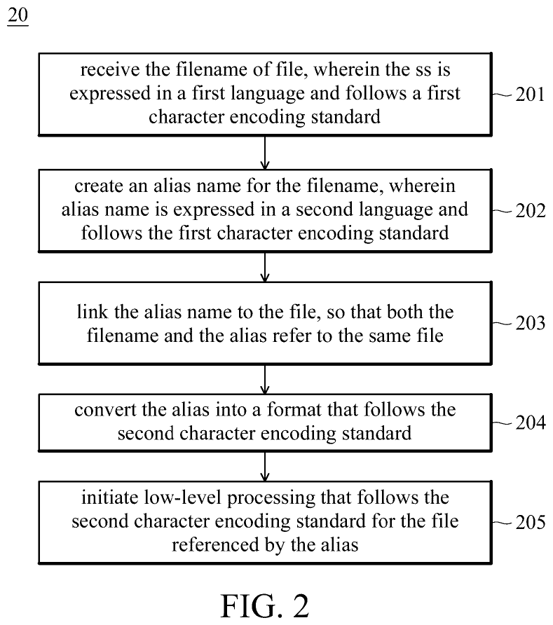

In various embodiments, the processing unit 11 loads the GUI program 13 from the storage unit 12 to implement a method that supports multi-language file processing. This will be explained below with reference to FIG. 2.

FIG. 2 is a flowchart of a method 20 that supports multi-language file processing according to an embodiment of the present disclosure. As shown in FIG. 2, the method 20 includes steps 201 to 205.

In step 201, the processing unit 11 receives the filename of file 14. This filename is expressed in a first language and follows a first character encoding standard.

In one embodiment, the first character encoding standard is Unicode.

It is noteworthy that the present disclosure does not limit the first language. In other words, the first language is not restricted to a single language and can be a mixture of multiple languages. More specifically, it can be a mix of letters, symbols, and emojis from various languages. For example, the filename of file 14 may be entirely in English, such as “Plan,”.

In step 202, the processing unit 11 creates an alias name for the filename. This alias name is expressed in a second language and follows the first character encoding standard.

In one embodiment, the second language is English.

In step 203, the processing unit 11 links the alias name to the file, so that both the filename and the alias refer to the same file.

In a file system, a link is a reference to a file and can be classified as a hard link or a soft link, also known as a symbolic link. A hard link is a direct reference to the target file. It allows both the target file's original name and the alias to point to the same memory block of the target file. A soft link is an indirect reference to the target file. It allows both the target file's original name and the alias to point to the absolute or relative path of the target file. When accessing a soft link, the system automatically redirects to the target file.

The present disclosure does not limit the method of linking. As long as the file can be accessed through the alias, the link used in step 203 can be a hard link or a soft link, also known as a symbolic link. In general, links can be created using command-line instructions or function calls. For example, in Linux, a hard link can be created using the ln command or the link( ) function, and a soft link or symbolic link can be created using the ln-s command or the symlink( ) function. In Windows, a soft link or symbolic link can be created using the mklink command or the CreateSymbolicLink( ) function, and a hard link can be created using the mklink/h command or the CreateHardLink( ) function.

It is important to note that within the same directory, the alias must be unique to avoid failure when creating a hard link or symbolic link. Therefore, in one implementation, the alias can be a random string of letters, a random alphanumeric string, a combination of a timestamp and a random string of letters, a universally unique identifier (UUID), or any combination of the above methods. However, the present disclosure is not limited to these examples.

In one embodiment, the processing unit 11 records the filename and its alias in a filename mapping table. The following <Table 1> shows a filename mapping table when the second language is English. As shown in <Table 1>, regardless of the language in which the filename is expressed, each filename corresponds to a unique alias in the mapping table. For example, the mixed Japanese and Korean filename “Japanese characters and Korean characters” may correspond to the alias “fkjdklw”.

TABLE 1

| filename | alias name |
|---|---|
| Japanese characters | Flkl213 |
| Chinese characters | Kjdkj33 |
| . . . | . . . |
| Japanese characters and Korean characters | fkjdklw |

The filename mapping table helps improve the efficiency of retrieving the correspondence between filenames and their aliases, especially when converting an alias back to the original filename for display in the interface of the GUI program. For more details, refer to step 303 below.

In step 204, the processing unit 11 converts the alias into a format that follows the second character encoding standard.

In one embodiment, the second character encoding standard is MBCS. In one implementation, the conversion between the first and second character encoding standards can be performed using application programming interfaces (APIs) provided by the operating system. For example, in Windows, when the first character encoding standard is Unicode, the WideCharToMultiByte( ) function can be used to convert Unicode characters into MBCS characters. Conversely, the MultiByteToWideChar( ) function can be used to convert MBCS characters into Unicode characters. Similarly, in Linux, the iconv( ) function can be used to perform conversions similar to those described above for Windows.

In one example, the second language is English, the first character encoding standard is Unicode, and the second character encoding standard is MBCS. Since English characters can be uniquely identified in both Unicode and MBCS, the use of APIs that handle character encoding standards does not require the language pack installed on the operating system. This makes the process more user-friendly for GUI program users, as it eliminates the need to install or switch between language packs.

In step 205, the processing unit 11 initiates low-level processing that follows the second character encoding standard for the file referenced by the alias.

Low-level processing refers to file operations or handling defined outside the GUI program. In one embodiment, the low-level processing includes calling functions from a library that follows the second character encoding standard. The library may be a static library, such as a file with the extension “.a” or “.lib”, or a dynamic library, such as a file with the extension “.so” or “.dll”. However, the present disclosure is not limited to these formats. In another embodiment, the file is an executable file, such as a file with the extension “.exe” or “.sh”, and the low-level processing includes executing that file. Since the alias was converted to follow the second character encoding standard in step 204, it can be directly used as a function parameter in functions that follow the second character encoding standard.

In one example, the first character encoding standard is Unicode and the second character encoding standard is MBCS. As previously mentioned, since MBCS was developed before Unicode, many existing MBCS libraries are available for use. For GUI program developers, these existing libraries can be used directly, which improves development efficiency and reduces the cost of developing and maintaining new libraries. The same applies to other character encoding standards that were developed before Unicode.

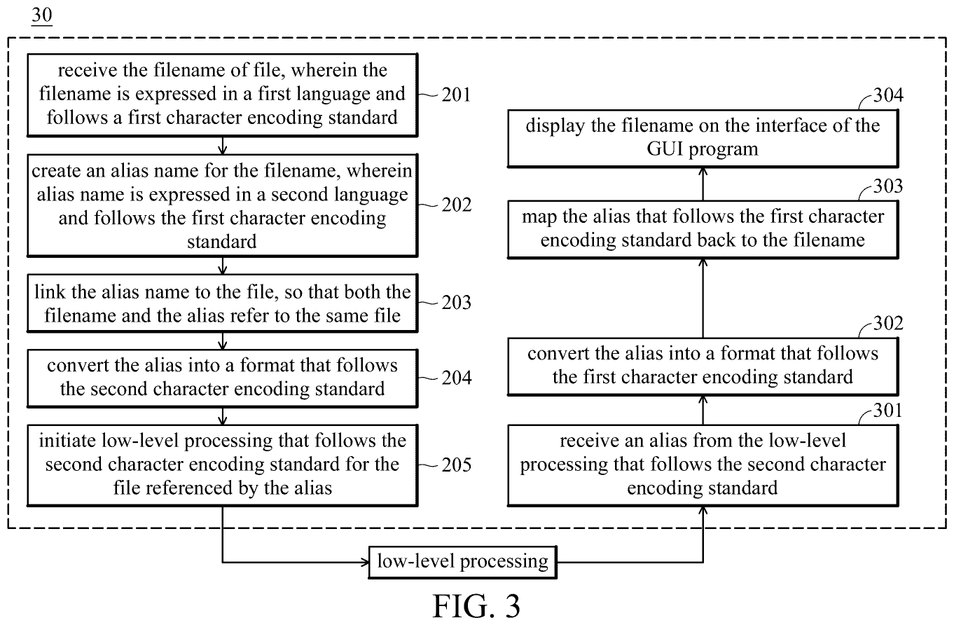

FIG. 3 is a flowchart of a method 30 for supporting multi-language file processing according to an embodiment of the present disclosure. As shown in FIG. 3, the method 30 includes steps 201 to 205 from FIG. 2 and further includes steps 301 to 304. In this embodiment, the low-level processing involves calling a function from a library that follows the second character encoding standard.

In step 301, the processing unit 11 receives an alias from the low-level processing that follows the second character encoding standard. In step 302, the processing unit 11 converts the alias into a format that follows the first character encoding standard. In step 303, the processing unit 11 maps the alias that follows the first character encoding standard back to the filename. In step 304, the processing unit 11 displays the filename on the interface of the GUI program.

In one embodiment, the processing unit 11 retrieves the filename by searching the filename mapping table using the alias in the first character encoding standard. In one example, the filename mapping table is as shown in <Table 1>. The processing unit 11 can perform a reverse lookup in the table based on the alias to obtain the corresponding filename. For example, the alias “fkjdklw” may correspond to the mixed Japanese and Korean filename “Japanese characters and Korean characters”.

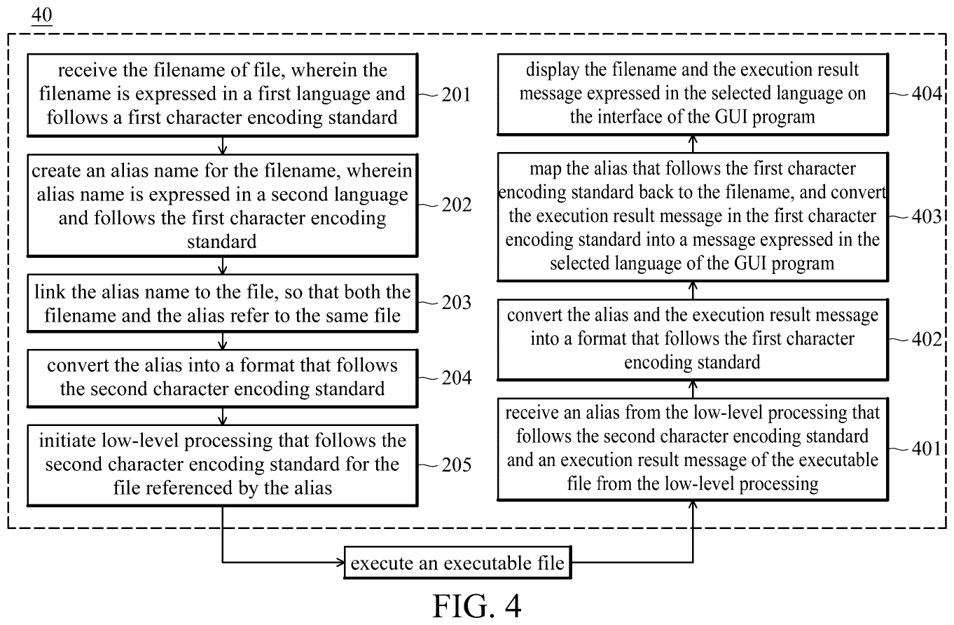

FIG. 4 is a flowchart of a method 40 for supporting multi-language file processing according to an embodiment of the present disclosure. As shown in FIG. 4, the method 40 includes steps 201 to 205 from FIG. 2 and further includes steps 401 to 404. In this embodiment, the low-level processing involves executing an executable file.

In fact, steps 401 to 404 also include steps 301 to 304 from FIG. 3. Compared to steps 301 to 304, in step 401, the processing unit 11 additionally receives the execution result message of the executable file from the low-level processing. In step 402, the processing unit 11 further converts the execution result message into a format that follows the first character encoding standard. In step 403, the processing unit 11 further converts the execution result message in the first character encoding standard into a message expressed in the selected language of the GUI program. In step 404, the processing unit 11 further displays the filename and the execution result message expressed in the selected language on the interface of the GUI program.

In one embodiment, the processing unit 11 also searches a pre-stored message mapping table based on the execution result message to obtain the corresponding message expressed in the selected language. The message mapping table stores common return codes generated during the execution of executable files, along with text messages used to explain the execution results.

In one example, the message mapping table is as shown in <Table 2>. The processing unit 11 obtains the corresponding text message from <Table 2> based on the return code of the executable file. For example, when the return code of the executable file is 0, it indicates that the execution was successful. When the return code is 3, it indicates that the execution failed because the file was not found.

TABLE 2

| return code | text message |
|---|---|
| 0 | Successful |
| . . . | . . . |
| 3 | File not found |
| 4 | File not accessible |
| . . . | . . . |

Since the meaning of each return code is known and the corresponding text messages can be predefined, the message mapping table may store only the text messages in a common language such as English. Alternatively, the message mapping table may store text messages in multiple languages, allowing the processing unit 11 to select the appropriate message based on the selected language. However, the present disclosure is not limited to these implementations.

The computer system and method for supporting multi-language file processing provided by this disclosure allow files with filenames in any language to be executed or processed by static libraries or dynamic libraries that do not support multiple languages. Furthermore, by creating an alias for the filename and linking the alias to the file, the file can be executed or processed by libraries that do not support multiple languages regardless of the language of the filename. In this way, developers of GUI programs do not need to develop separate libraries to support multiple languages, which can reduce the cost of development and maintenance. In addition, for users of the GUI program, there is no need to manually install or switch system locale or language packs, making the use of the GUI program simpler and more user friendly.

The above paragraphs describe various embodiments. It is evident that the teachings herein can be implemented in multiple ways, and any specific architecture or function disclosed in the examples is merely a representative case. According to the teachings of this document, those skilled in the art should understand that each embodiment disclosed can be implemented independently or two or more embodiments can be combined for implementation.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A computer system for supporting multi-language file processing, comprising:
a storage unit configured to store a graphical user interface (GUI) program and a file; and
a processing unit configured to load the GUI program from the storage unit to perform:
receiving a filename of the file, wherein the filename is represented in a first language and follows a first character encoding standard;
creating an alias name for the filename, wherein the alias name is represented in a second language and follows the first character encoding standard;
linking the alias name to the file such that both the filename and the alias name reference the file; and
converting the alias name to follow a second character encoding standard to initiate a low-level process referencing the file via the alias name, the low-level process follows the second character encoding standard.

2. The computer system as claimed in claim 1, wherein the second language is English.

3. The computer system as claimed in claim 1, wherein the first character encoding standard is Unicode, and the second character encoding standard is a Multi-byte Character Set (MBCS).

4. The computer system as claimed in claim 1, wherein the low-level process comprises calling a function in a library that follows the second character encoding standard.

5. The computer system as claimed in claim 1, wherein the processing unit further performs:
recording the filename and the alias name in a filename mapping table; and
retrieving the filename from the filename mapping table based on the alias name that follows the first character encoding standard.

6. A method for supporting multi-language file processing, implemented on a computer system, the computer system comprising a storage unit and a processing unit, the storage unit storing a graphical user interface (GUI) program and a file, and the processing unit loading the GUI program from the storage unit to perform the method, the method comprising:
receiving a filename of the file, wherein the filename is represented in a first language and follows a first character encoding standard;
creating an alias name for the filename, wherein the alias name is represented in a second language and follows the first character encoding standard;
linking the alias name to the file such that both the filename and the alias name reference the file; and
converting the alias name to follow a second character encoding standard to launch a low-level process referencing the file via the alias name, the low-level process follows the second character encoding standard.

7. The method as claimed in claim 6, further comprising:
receiving the alias name from the low-level process, the alias name following the second character encoding standard, and converting the alias name to follow the first character encoding standard;
mapping the alias name that follows the first character encoding standard back to the filename; and
displaying the filename on the interface of the GUI program.

8. The method as claimed in claim 6, wherein the second language is English.

9. The method as claimed in claim 6, wherein the first character encoding standard is Unicode, and the second character encoding standard is a Multi-byte Character Set (MBCS).

10. The method as claimed in claim 6, further comprising:
recording the filename and the alias name in a filename mapping table; and
retrieving the filename from the filename mapping table based on the alias name that follows the first character encoding standard.

11. The method as claimed in claim 6, wherein the file is an executable file, and the low-level process comprises executing the executable file.

12. The method as claimed in claim 11, further comprising:
receiving an execution result message of the executable file from the low-level process;
converting the execution result message to follow the first character encoding standard; and
converting the execution result message that follows the first character encoding standard into a representation in a selected language of the GUI program, and displaying it on the interface of the GUI program.
